(19) United States
(12) Patent Application Publication
(10) Pub. No.: US 2005/0138807 A1
(43) Pub. Date: Jun. 30, 2005

(54) Evaporator manufacturing method and refrigerator with the evaporator

(75) Inventors: Jin-ho Kim, Kwangju (KR); Eui-young Chang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-Si (KR)

(21) Appl. No.: 10/821,171

(22) Filed: Apr. 9, 2004

(30) Foreign Application Priority Data
Dec. 31, 2003 (KR) 2003-102134

(51) Int. Cl. F25B 47/00; B21D 53/02; B23P 15/26; B21K 21/00; B21D 53/06; B23P 17/00; B21D 51/18

(52) U.S. Cl. 29/890.035; 29/890.07; 29/890.03

(57) ABSTRACT

An evaporator manufacturing method includes providing cooling fins each formed with a pair of coolant tube accommodation parts, and expanding a first coolant tube and a second coolant tube after inserting the first coolant tube and the second coolant tube into the coolant tube accommodation parts of the plurality of cooling fins; providing a first jig and a second jig at different levels to bend the expanded first coolant tube and the expanded second coolant tube; bending the first coolant tube around the first jig alternately to form several horizontal parts spaced apart from each other along a vertical direction, and at the same time bending the second coolant tube around the second jig alternately to form several second horizontal parts spaced apart from each other along the vertical direction so that the second horizontal parts are positioned to the rear of spaces between the respective first horizontal parts; and connecting the first coolant tube and the second coolant tube. The coolant tube accommodation parts of each cooling fin are coupled to the first horizontal part and the second horizontal part, and inclined at an inclination angle to the vertical direction.

### CROSS-REFERENCE TO RELATED APPLICATION

This application claims the benefit of Korean Patent Application No. 2003-0102134, filed Dec. 31, 2003, in the Korean Intellectual Property Office, the disclosure of which is incorporated herein by reference.

### BACKGROUND OF THE INVENTION

1. Field of the Invention

The present invention relates to an evaporator manufacturing method and a refrigerator with the evaporator, and in particular, to an evaporator manufacturing method and a refrigerator with the evaporator enhancing manufacturing process and improving cooling efficiency.

2. Description of the Related Art

Generally, an evaporator includes a coolant tube through which coolant with high pressure and high temperature passes, and a coolant tube supporter supporting the coolant tube. The evaporator is installed in an air conditioning apparatus or a refrigerator and functions to generate cooling air. Also, a defrosting apparatus is generally provided on a position close to such evaporator to remove frost formed on the coolant tube and a cooling fin.

FIGS. 1 and 2 are a perspective view and a longitudinal sectional view, respectively, of a conventional evaporator. As shown therein, a conventional evaporator 120 includes coolant tubes 121 and 125 having bending parts along a vertical direction, at least one cooling fin 130 coupled to the coolant tubes 121 and 125, and a coolant tube supporter 127 provided on opposite sides to support the coolant tubes 121 and 125.

The coolant tubes 121 and 125 are provided as a pair in the front and rear. In other words, the coolant tubes 121 and 125 include a first coolant tube 121 provided in the front and having several bending parts along a vertical direction, and a second coolant tube 125 connected to the first coolant tube 121 and also having bending parts to the rear of the first coolant tube. Also, the second coolant tube 125 is spaced from the rear of the first coolant tube 121 and provided in parallel to the first coolant tube 121.

The cooling fin 130 is shaped as a rectangular plate and coupled to the first coolant tube 121 and the second coolant tube 125 in parallel. Also, the cooling fin 130 is provided with a pair of coolant tube accommodating parts 131 to accommodate the first coolant tube 121 and the second coolant tube 125.

The coolant tube supporter 127 includes tube supporters 128 having holes in the middle to accommodate ends of the coolant tubes 121 and 125 having bending parts on opposite sides of the evaporator 120.

Accordingly, the conventional evaporator 120 can cool surrounding air by heat exchange of the surrounding air circulating around the coolant tubes 121 and 125 and the cooling fin 130 as the coolant with low pressure and low temperature passes through the coolant tubes 121 and 125.

However, the cooling efficiency of the conventional evaporator 120 may deteriorate. A reason for deterioration of the cooling efficiency is that a small space between the first coolant tube 121 and the second coolant tube 125 may hinder smooth flow of the surrounding air when the second coolant tube 125 is provided in the rear of the first coolant tube 121. Also, in the conventional evaporator 120, a thickness of the evaporator 120 may increase because the first coolant tube 121 and the second tube 125 have to be spaced with a proper distance from each other to let the surrounding air flow through between the first coolant tube 121 and the second coolant tube 125.

Also, because the cooling fin 130 provided in the conventional evaporator 120 is coupled to the first and second coolant tubes 121 and 125 horizontally, defrosted water formed by the defrosting apparatus cannot be discharged easily along the cooling fin 130. Accordingly, there is another disadvantage that the defrosted water is frozen again, lowering the cooling efficiency.

### SUMMARY OF THE INVENTION

Accordingly, it is an aspect of the present invention to provide an evaporator manufacturing method and a refrigerator with the evaporator enhancing manufacturing process and improving cooling efficiency.

Additional aspects and/or advantages of the invention will be set forth in part in the description which follows and, in part, will be obvious from the description, or may be learned by practice of the invention.

The foregoing and other aspects of the present invention are achieved by providing an evaporator manufacturing method including providing at least one cooling fin formed with a pair of coolant tube accommodation parts, and expanding a first coolant tube and a second coolant tube after inserting the first coolant tube and the second coolant tube into the coolant tube accommodation parts of the cooling fin; providing a first jig and a second jig at different levels to bend the expanded first coolant tube and the expanded second coolant tube; bending the first coolant tube around the first jig alternately to form several first horizontal parts spaced from each other along a vertical direction, and at the same time bending the second coolant tube around the second jig alternately to form several second horizontal parts spaced from each other along the vertical direction so that the second horizontal parts are positioned in the rear of spaces between the respective first horizontal parts; and connecting a first end of the first coolant tube and a first end of the second coolant tube, in which the coolant tube accommodation parts of each cooling fin are coupled to the first horizontal part and the second horizontal part, and are inclined at an inclination angle to the vertical direction.

According to an aspect of the invention, each second horizontal part is provided in the rear center part between the respective first horizontal parts.

According to another aspect of the invention, each cooling fin has a bottom end provided on a bottom side of the cooling fin, and a round part rounded on upper opposite corners of the bottom end.

According to a further aspect of the invention, the inclination angle between a longitudinal direction of the cooling fin and the vertical direction is approximately between 50 and 75 degrees.

According to an additional aspect of the invention, the cooling fin has at least one protrusion protruding orthogonally from a surface of the cooling fin.

According to another aspect of the invention, the cooling fin is of a rectangular plate shape.

According to a further aspect of the present invention, the above and other aspects may also be achieved by providing a refrigerator including an evaporator manufactured by the evaporator manufacturing method thus described; a main body installed with the evaporator, and formed with at least one storage compartment supplied with cooling air generated from the evaporator; and at least one door opening/closing an opening of the storage compartment.

According to an additional aspect of the invention, the main body is provided with an evaporator accommodation part to accommodate the evaporator, and the cooling fin provided in the evaporator is adjacent to a wall of the evaporator accommodation part, and inclined toward the wall of the evaporator accommodation part.

### BRIEF DESCRIPTION OF THE DRAWINGS

These and/or other aspects and advantages of the present invention will become apparent and more readily appreciated from the following description of the aspects, taken in conjunction with the accompany drawings of which:

FIG. 1 is a perspective view of an evaporator installed in a conventional refrigerator;

FIG. 2 is a cross sectional view of the evaporator in FIG. 1, taken across line II-II;

FIG. 3 is a perspective view of an evaporator manufactured according to an embodiment of the present invention;

FIGS. 4 and 5 are a partial front view of the evaporator in FIG. 3 and a cross sectional view of the evaporator in FIG. 3, taken across line V-V, respectively;

FIGS. 6 through 8 illustrate manufacturing processes of the evaporator according to an embodiment of the present invention;

FIG. 9 is a front view of a refrigerator including the evaporator manufactured according to an embodiment of the present invention;

FIG. 10 is a partial exploded perspective view of the refrigerator in FIG. 9; and

FIG. 11 is a partial longitudinal sectional view of the refrigerator in FIG. 10.

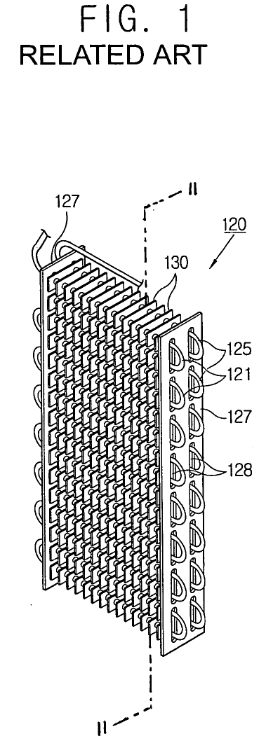

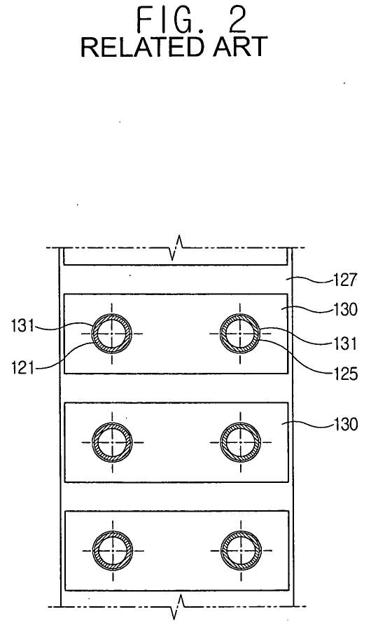

### DETAILED DESCRIPTION OF THE PREFERRED EMBODIMENTS

Reference will now be made in detail to aspects of the present invention, examples of which are illustrated in the accompanying drawings, wherein like reference numerals refer to like elements throughout. The aspects are described below in order to explain the present invention by referring to the figures.

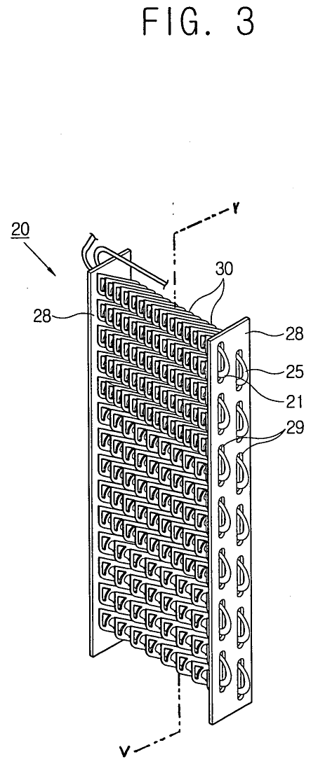

As shown in FIGS. 3 through 5, an evaporator 20 manufactured according to the embodiment of the present invention including a first set of coolant tubes 21 spaced from each other along a vertical direction and having first horizontal parts 22 formed along a transverse direction relative to the vertical direction, a second coolant tube 25 having second horizontal parts 26 positioned to the rear of a space between the first horizontal parts 22 of the first coolant tube 21, at least one cooling fin 30 coupled to the first coolant tube 21 and the second coolant tube 25 and forming an inclination angle to the vertical direction, and a pair of coolant tube supporters 28 provided on opposite sides to support the first and second coolant tubes 21 and 23.

The first coolant tube 21 includes a first bending part 23 bent several times alternately to form the first horizontal parts 22. Also, a first end of the first coolant tube 21 is connected to a first end of the second coolant tube 25 so that the coolant can pass through the first coolant tube 21 and the second coolant tube 25 continuously. Also, the first coolant tube 21 is formed horizontally, and is accommodated in the first coolant tube accommodation part 31 of the cooling fin 30.

The second coolant tube 25 has a second bending part 27 bent several times alternately to form the plurality of second horizontal parts 26. Also, the second coolant tube 25 is provided to the rear of the first coolant tube 21, spaced by a particular distance. Also, the second horizontal part 26 is formed horizontally, and is accommodated in the second coolant tube accommodation part 32 of the cooling fin 30.

The cooling fin 30 includes the first coolant tube accommodation part 31 and the second coolant tube accommodation part 32 with holes in the middle to accommodate the first coolant tube 21 and the second coolant tube 25. Also, the cooling fin 30 has a bottom end 33 provided in a lower part of the cooling fin 30, and a round part 35 rounded on upper opposite corners of the bottom end 33. Also, the inclination angle ‘α’ that a longitudinal direction of the cooling fin 30 forms relative to a vertical direction is between 50 and 75 degrees. Further, the cooling fin 30 has a rectangular plate shape, and includes at least one protrusion 37 protruding in a transverse direction to a surface of the cooling fin.

The round part 35 is rounded to have a radius ranging approximately from 5 mm and 20 mm. However, the radius may be between 3 mm and 5 mm, or between 20 mm and 50 mm according to a size of the cooling fin 30 so that the water drops formed on the top area of the cooling fin 30 flow toward the bottom end 33 easily.

The protrusion 37 protrudes from the surface of the cooling fin 30 to prevent the cooling fin 30 from being bent easily. Also, the protrusion 37 may maximize cooling efficiency by creating turbulence in the surrounding air flow. Although the protrusion 37 is preferably provided in triplicate on the surface of the cooling fin 30, it may be provided singly, in a pair, or in quadruplet.

The coolant tube supporter 28 has tube supporters 29 with holes in the middle to accommodate and support the first bending part 23 of the first coolant tube 21 and the second bending part 27 of the second coolant tube 25, respectively, on opposite sides of the evaporator 20.

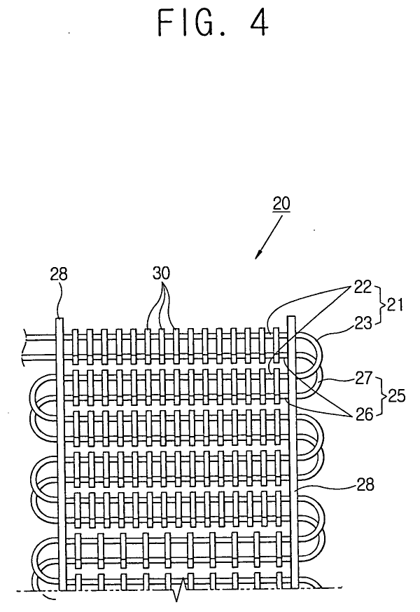

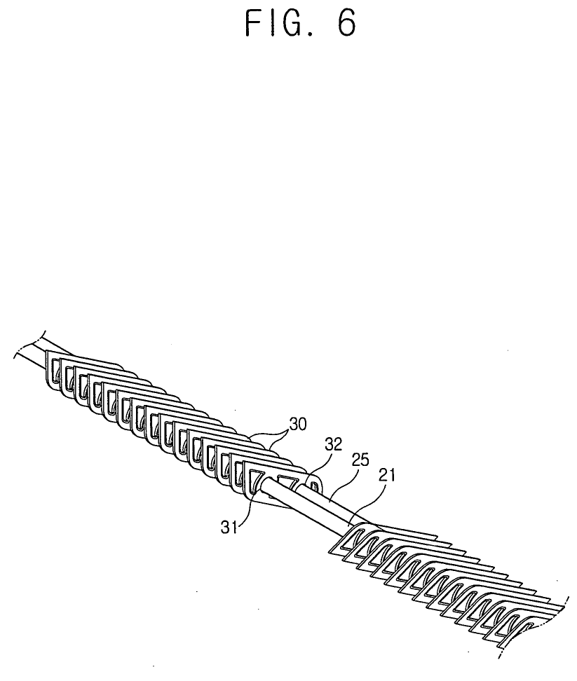

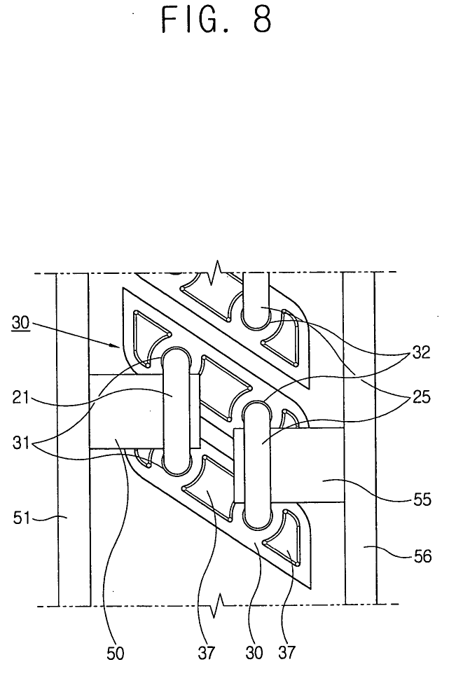

As shown in FIGS. 6 and 8, a manufacturing method of the evaporator according to an embodiment of the present invention includes providing the at least one cooling fin 30 formed with a pair of coolant tube accommodation parts 31 and 32, expanding the first and second coolant tubes after inserting the first and second coolant tubes 21 and 25 into the coolant tube accommodation parts 31 and 32 of the cooling fin 30, respectively, providing a first jig 50 and a second jig 55 at different levels for bending the expanded first and second coolant tubes 21 and 25, respectively, bending the first coolant tube 21 around the first jig 50 alternately to form the first horizontal parts 22 (refer to FIG. 4) spaced apart from each other along a vertical direction and bending the second coolant tube 25 around the second jig 55 alternately to form the second horizontal parts 26 (refer to FIG. 4) spaced apart from each other along the vertical direction and positioned to the rear of the space between the respective first horizontal parts 22, and connecting the first end of the first coolant tube 21 and the first end of the second coolant tube 25. Also, the coolant tube accommodation parts 31 and 32 of a respective cooling fin 30 are coupled to the first horizontal part 22 and the second horizontal part 26 and provided at an inclination angle to the vertical direction.

A manufacturing method of the evaporator according to an embodiment of the present invention is described in detail below.

First, the coolant tube accommodation parts 31 and 32 passing through the cooling fin 30 is formed by a press work. Also, the cooling fin 30 is provided in a rectangular plate shape. Further, the first and second coolant tube accommodation parts 31 and 32 are inserted with coolant tubes having radii smaller than those of the coolant tube accommodation parts 31 and 32. The coolant tube can be expanded by pushing a ball (not shown) having radius bigger than that of the coolant tube through the coolant tube. Herein, an outer surface of the expanded first and second coolant tubes 21 and 25 are pressed against the first and second coolant tube accommodation parts 31 and 32 of the cooling fin 30 so that the respective cooling fin 30 cannot move relative to the first and second coolant tubes 21 and 25.

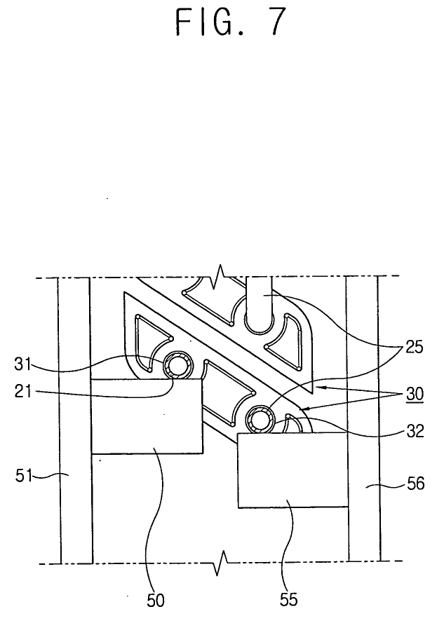

As shown in FIG. 7, the first jig 50 and the second jig 55 are provided opposed to each other so that the first coolant tube 21 and the second coolant tube 26 can be bent at the same time. Also, on ends of the first jig 50 and the second jig 55 opposed to each other, a first jig plate 51 and a second jig plate 56 are provided, respectively, to support the first jig 50 and the second jig 55. Further, the first jig 50 and the second jig 55 are installed at different levels to bend the first coolant tube 21 and the second coolant tube 25, respectively, so that each second horizontal part 26 of the second coolant tube 25 can be positioned to the rear of space between the respective first horizontal parts 22 of the first coolant tube 21. Also, the first jig 50 and the second jig 55 are movable to be separated from the first coolant tube 21 and the second coolant tube 25 after bending the first coolant tube 21 and the second coolant tube 25. In other words, first ends of the first jig plate 51 and the second jig plate 56 are connected rotatably so that second ends thereof are movable toward and away from each other. Accordingly, by providing the first jig 50 and the second jig 55 on the second ends of the first jig plate 51 and the second jig plate 56, respectively, the first jig 50 and the second jig 55 can be moved easily.

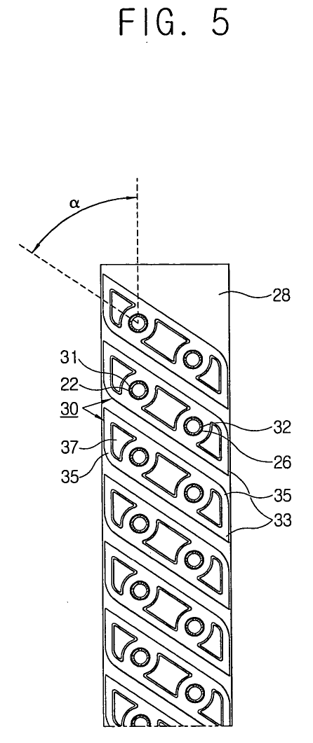

The first coolant tube 21 and the second coolant tube 25 are bent relative to the first jig 50 and the second jig 55 alternately to take a zigzag shape shown in FIG. 4. Also, on completion of bending the first coolant tube 21 and the second coolant tube 25, the first ends provided on the respective bottom of the first and second coolant tubes 21 and 25 are connected by welding. Accordingly, because the respective second horizontal parts 26 are positioned between the first horizontal parts 22, a thickness can be reduced while keeping a proper distance between the first horizontal part 22 and second horizontal part 26. Also, as shown in FIG. 5, the cooling efficiency can be improved by enhancing turbulent air current in the surrounding air flowing from a lower area to a higher area because the first horizontal part 22 and the second horizontal part 26 are formed in a zigzag shape at different levels.

Also, the cooling fin 30 coupled to the first coolant tube 21 and the second coolant tube 25 is inclined by an inclination angle based on a difference of levels at which the first horizontal part 22 and the second horizontal part 26 are positioned. The inclination angle ‘α’ may be between 50 and 75 degrees as described above. Also, the turbulent air current surrounding the cooling fin 30 enhanced by the protrusion 37 formed on the cooling fin 30 improves the cooling efficiency more.

Accordingly, the manufacturing method of the evaporator according to the embodiment of the present invention is convenient as the first coolant tube 21 and the second coolant tube 25 are bent as one body without a connection part using the first jig 50 and the second jig 55. Also, the manufacturing method of the evaporator according to the embodiment of the present invention can reduce the thickness by installing the first horizontal part 22 and the second horizontal part 26 in a zigzag shape, and can improve the cooling efficiency.

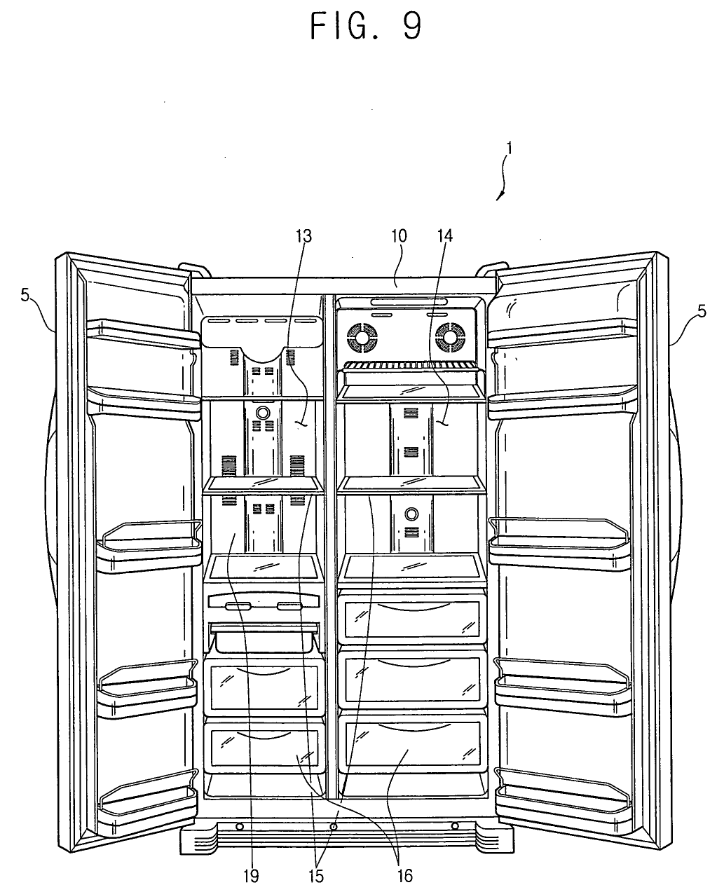

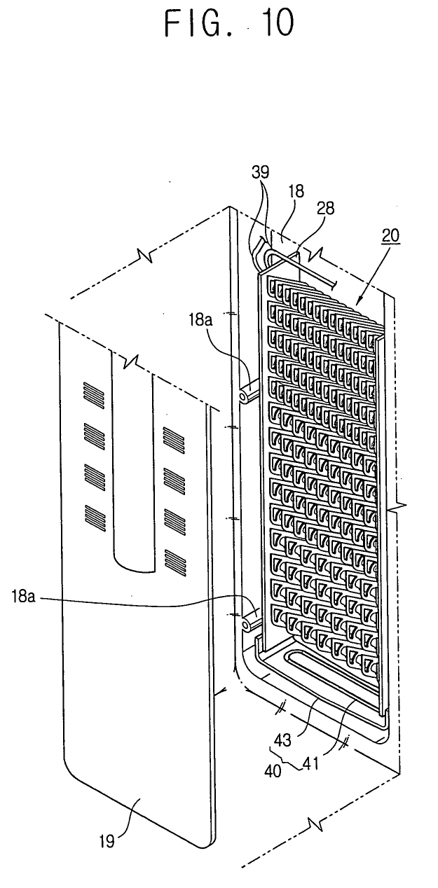

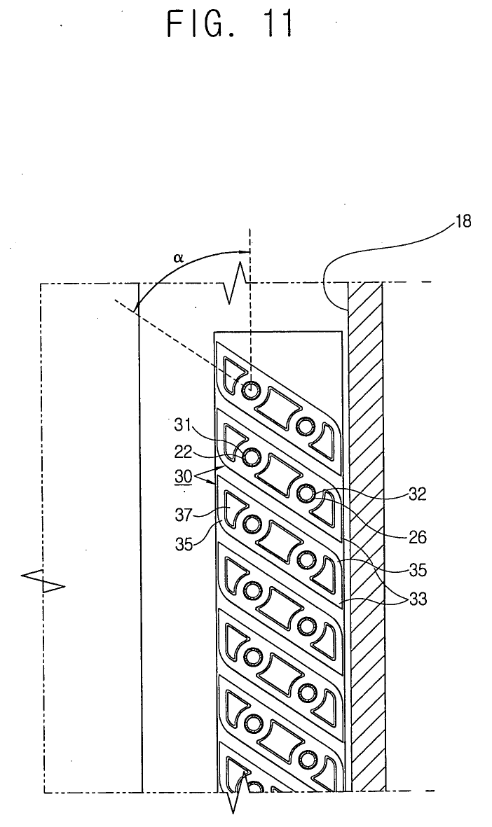

FIGS. 9 through 11 illustrate a refrigerator installed with the evaporator manufactured by an evaporator manufacturing method according to an embodiment of the present invention, a partial perspective view of the refrigerator, and a cross sectional view of the refrigerator, respectively. As shown therein, a refrigerator 1 according to an embodiment of the present invention includes a main body 10 having storage compartments such as a freezer compartment 13 and a refrigerator compartment 14, a door 5 rotatably covering a front opening of the freezer compartment 13 and the refrigerator compartment 14, a freezing apparatus provided in the rear of the main body 10 and having an evaporator 20 generating cooling air for cooling the freezer compartment 13 and the refrigerator compartment 14, and a defrosting apparatus 40 removing frost formed on a surface of the evaporator 20.

The freezer compartment 13 and the refrigerator compartment 14 of the main body 10 are provided with shelves 15 and holders 16 containing an inventory such as foods. Also, a rear area of the main body 10 is provided with an evaporator accommodation part 18 installed with the evaporator 20, and an accommodation part cover 19 provided in the front of the evaporator accommodation part 18 and covering the evaporator accommodation part 18.

Although the evaporator accommodation part 18 is provided on a rear area of the freezer compartment 13, it may be provided on a rear area of the refrigerator compartment 14, or on the rear areas of both the freezer compartment 13 and the refrigerator compartment 14. Also, the evaporator accommodation part 18 is provided with bosses 18A to couple the evaporator 20 and the accommodation part cover 19 with screws.

The refrigerator includes a compressor (not shown) compressing the coolant in a gaseous state into a state of high temperature and high pressure, a condenser (not shown) condensing the coolant in a gas state compressed by the compressor (not shown) into a liquid state, a capillary tube (not shown) converting the liquefied coolant into a state of low temperature and low pressure, the evaporator 20 cooling surrounding air by absorbing latent heat to evaporate the liquefied coolant converted into a state of low pressure and low temperature by the capillary tube, and a connection pipe 39 connecting the compressor, the capillary tube, and the evaporator 20 to circulate the coolant. Accordingly, the freezer compartment 13 and the refrigerator compartment 14 can be cooled as the cooled air surrounding the evaporator 20 is circulated into the freezer compartment 13 and the refrigerator compartment 14.

Also, in the cooling fin 30 provided on the evaporator 20, to enable the defrosted water defrosted by the defrosting apparatus 40 to flow downward to the bottom end 33, an angle ‘α’ that a longitudinal direction of the cooling fin 30 forms with a vertical direction in which the defrosted water flows by gravity may be between 50 and 75 degrees. Also, each cooling fin 30 is inclined so that the bottom end 33 contacts an inner wall of the evaporator accommodation part 18. Accordingly, the defrosted water which reaches the bottom end 33 of the cooling fin 30 can flow downward along a wall of the evaporator accommodation part 18. Also, an outlet (not shown) is provided on a lower area of the evaporator accommodation part 18 to discharge the defrosted water which flows from the cooling fin 30. However, an additional water accommodation part (not shown) may be provided to accommodate the defrosted water.

Also, on opposite corners of the cooling fin 30, round parts 35 are provided to enable the defrosted water to flow down to the bottom end 33 along an edge of the cooling fin 30 easily as described above. At least one protrusion 37 protruding orthogonally to a surface of the cooling fin 30 is provided.

The bottom end 33 is adjacent to the wall of the evaporator accommodation part 18.

The defrosting apparatus 40 includes a defrosting heater 41 heating by electricity, and a heater supporter 43 supporting the defrosting heater 41. Also, the heater supporter 43 is installed on a bottom area of the evaporator accommodation part 18 so that the defrosting heater 41 can be positioned on a lower side of the evaporator 20. However, such a defrosting apparatus 40 may be provided in the front or the rear of the evaporator 20, and the defrosting heater 41 may be replaced by another heating device.

With such configurations, an operation process of the refrigerator according to the embodiment of the present invention will be described.

First, when the compressor (not shown) operates, the first horizontal part 22 of the first coolant tube 21 and the second horizontal part 26 of the second coolant tube 25 are provided in zigzag shape as shown in FIG. 5, to enhance the turbulent air current in the surrounding air. Accordingly, the cooling efficiency can be improved, and the thickness of the evaporator 20 is reduced compared to a conventional evaporator so that a volume of a storage compartment of a refrigerator can be increased. Also, when the defrosting apparatus 40 operates, the cooling fin 30 is inclined at an inclination angle and the round parts 35 are formed on the cooling fin 30 so that the defrosted water can be discharged easily.

In the embodiment of the present invention described above, the manufacturing method of the evaporator according to the embodiment of the present invention using a first coolant tube and a second coolant tube is described. However, a third coolant tube provided in the rear of the second coolant tube and coupled to the cooling fin may be provided.

An embodiment of the present invention describes a refrigerator with the evaporator manufactured by the manufacturing method of the evaporator described above. However, such an evaporator may be applied not only to a refrigerator, but also to various heat exchanging systems such as an air conditioning apparatus.

As described above, according to an embodiment of the present invention, an evaporator manufacturing method reducing a thickness of an evaporator, improving the cooling efficiency, and bending each coolant tube as one body easily by without a connection part is provided.

Also, by installing the evaporator manufactured by the evaporator manufacturing method according to an embodiment of the present invention, the cooling efficiency of the refrigerator can be improved and a volume of the storage compartment can be increased as the thickness of the evaporator is reduced while discharging defrosted water easily during a defrosting process.

Although a few embodiments of the present invention have been shown and described, it will be appreciated by those skilled in the art that changes may be made in these aspects without departing from the principles and spirit of the invention, the scope of which is defined in the appended claims and their equivalents.

1. A method of manufacturing an evaporator, comprising:
forming at least one cooling fin with at least first and second coolant tube accommodation parts;
inserting first and second coolant tubes into the first and second coolant tube accommodation parts, respectively;
expanding the first and second coolant tubes after the inserting;
bending the first coolant tube around a first jig at a first position and the second coolant tube around a second jig at a second position, the first and second positions spaced apart at different levels relative a first position along a first axis, to form first and second horizontal parts of the first and second coolant tubes, respectively;
repeating the bending of the first and second coolant tubes at least one further time at a another position along the first axis to form at least third and fourth horizontal parts of the first and second coolant tubes, respectively; and
connecting a first end of the first coolant tube to a first end of the second coolant tube,
wherein the first and second coolant tube accommodation portions of the cooling fin are coupled to a corresponding horizontal part of the first and second coolant tubes, respectively, and
wherein the cooling fin is inclined at an inclination angle relative to the first axis.

2. The method according to claim 1, wherein each second horizontal part is provided in a rear center part between the corresponding first horizontal parts.

3. The method according to claim 1, wherein each cooling fin includes a bottom end and a round part rounded on upper opposite corners of the bottom end.

4. The method according to claim 3, wherein the inclination angle between a longitudinal direction of the cooling fin and the first axis is approximately between 50 and 75 degrees.

5. The method according to claim 1, wherein the cooling fin includes at least one protrusion protruding orthogonally from a surface of the cooling fin.

6. The method according to claim 1, wherein the cooling fin has a substantially rectangular plate shape.

7. A refrigerator comprising:
an evaporator manufactured by:
forming at least one cooling fin with at least first and second coolant tube accommodation parts,
inserting first and second coolant tubes into the first and second coolant tube accommodation parts, respectively,
expanding the first and second coolant tubes after the inserting,
bending the first coolant tube around a first jig at a first position and the second coolant tube around a second jig at a second position, the first and second positions spaced apart at different levels relative a first position along a first axis, to form first and second horizontal parts of the first and second coolant tubes, respectively,
repeating the bending of the first and second coolant tubes at least one further time at a another position along the first axis to form at least third and fourth horizontal parts of the first and second coolant tubes, respectively, and
connecting a first end of the first coolant tube to a first end of the second coolant tube;
a main body including the evaporator, and having at least one storage compartment supplied with cooling air generated from the evaporator; and
at least one door covering an opening of the storage compartment,
wherein the first and second coolant tube accommodation portions of the cooling fin are coupled to a corresponding horizontal part of the first and second coolant tubes, respectively, and
wherein the cooling fin is inclined at an inclination angle relative to the first axis.

8. The refrigerator according to claim 7, wherein the main body includes an evaporator accommodation part to accommodate the evaporator, and
wherein the cooling fin in the evaporator is adjacent to a wall of the evaporator accommodation part, and is inclined toward the wall of the evaporator accommodation part.

9. A refrigerator comprising:
an evaporator manufactured by:
forming at least one cooling fin with at least first and second coolant tube accommodation parts,
inserting first and second coolant tubes into the first and second coolant tube accommodation parts, respectively,
expanding the first and second coolant tubes after the inserting,
bending the first coolant tube around a first jig at a first position and the second coolant tube around a second jig at a second position, the first and second positions spaced apart at different levels relative a first position along a first axis, to form first and second horizontal parts of the first and second coolant tubes, respectively,
repeating the bending of the first and second coolant tubes at least one further time at a another position along the first axis to form at least third and fourth horizontal parts of the first and second coolant tubes, respectively, and
connecting a first end of the first coolant tube to a first end of the second coolant tube;
a main body including the evaporator and at least one storage compartment supplied with cooling air generated from the evaporator; and
at least one door covering an opening of the storage compartment,
wherein the first and second coolant tube accommodation portions of the cooling fin are coupled to a corresponding horizontal part of the first and second coolant tubes, respectively,
wherein the cooling fin is inclined at an inclination angle relative to the first axis, and
wherein inclination angle between a longitudinal direction of the cooling fin and the first axis is between approximately 50 and 75 degrees.

10. The refrigerator according to claim 9, wherein the main body includes an evaporator accommodation part to accommodate the evaporator, and
wherein the cooling fin in the evaporator is adjacent to a wall of the evaporator accommodation part, and is inclined toward the wall of the evaporator accommodation part.

11. A refrigerator comprising:
an evaporator manufactured by:
forming at least one cooling fin with at least first and second coolant tube accommodation parts,
inserting first and second coolant tubes into the first and second coolant tube accommodation parts, respectively,
expanding the first and second coolant tubes after the inserting,
bending the first coolant tube around a first jig at a first position and the second coolant tube around a second jig at a second position, the first and second positions spaced apart at different levels relative a first position along a first axis, to form first and second horizontal parts of the first and second coolant tubes, respectively,
repeating the bending of the first and second coolant tubes at least one further time at another position along the first axis to form at least third and fourth horizontal parts of the first and second coolant tubes, respectively, and
connecting a first end of the first coolant tube to a first end of the second coolant tube;
a main body including the evaporator and at least one storage compartment supplied with cooling air generated from the evaporator; and
at least one door covering an opening of the storage compartment,
wherein the first and second coolant tube accommodation parts of the cooling fin are coupled to a corresponding horizontal part of the first and second coolant tubes, respectively,
wherein the cooling fin is inclined at an inclination angle relative to the first axis, and
wherein the cooling fin includes at least one protrusion protruding orthogonally from a surface of the cooling fin.

12. The refrigerator according to claim 11, wherein the main body includes an evaporator accommodation part to accommodate the evaporator, and
wherein the cooling fin in the evaporator is adjacent to a wall of the evaporator accommodation part, and is inclined toward the wall of the evaporator accommodation part.

13. The method according to claim 3, wherein the round part forms a section of a circle having a radius between approximately 3 mm and 50 mm.

14. The method according to claim 5, wherein the protrusion creates turbulent air flowing about the protrusion.

15. The method according to claim 1, further comprising:
supporting the first and second jigs with first and second jig plates on opposite ends of the first and second jig plates during the bending of the first and second coolant tubes.

16. The method according to claim 1, wherein the bending of the first and second coolant tubes is performed simultaneously.

17. The method according to claim 15, wherein a respective first end of the first and second jigs are rotatably connected to a corresponding jig plate so that a respective second end of the first and second jigs are movable toward and away from each other.

18. The method according to claim 1, wherein the bending of the first and second coolant tubes imparts a zigzag shape to the first and second coolant tubes.

19. An air conditioner comprising:
an evaporator manufactured by:
forming at least one cooling fin with at least first and second coolant tube accommodation parts,
inserting first and second coolant tubes into the first and second coolant tube accommodation parts, respectively,
expanding the first and second coolant tubes after the inserting,
bending the first coolant tube around a first jig at a first position and the second coolant tube around a second jig at a second position, the first and second positions spaced apart at different levels relative a first position along a first axis, to form first and second horizontal parts of the first and second coolant tubes, respectively,
repeating the bending of the first and second coolant tubes at least one further time at a another position along the first axis to form at least third and fourth horizontal parts of the first and second coolant tubes, respectively, and
connecting a first end of the first coolant tube to a first end of the second coolant tube,
wherein the first and second coolant tube accommodation portions of the cooling fin are coupled to a corresponding horizontal part of the first and second coolant tubes, respectively,
wherein the cooling fin is inclined at an inclination angle relative to the first axis, and
wherein the cooling fin includes at least one protrusion protruding orthogonally from a surface of the cooling fin.

20. The method according to claim 3, wherein the inclination angle and the round parts of the cooling fin cause defrosted water to discharge from the evaporator.

21. The method according to claim 3, wherein the bottom end of the cooling fin is adjacent to a wall of the evaporator accommodation part.

22. The method according to claim 1, wherein the inclination angle of the cooling fin is based on a difference in the respective positions of the first and second horizontal parts along the first axis.

23. The method according to claim 5, wherein the protrusion prevents the cooling fin from substantially bending.
